(19) United States
(12) Patent Application Publication
(10) Pub. No.: US 2009/0131618 A1
(43) Pub. Date: May 21, 2009

(54) Pre-Stretched Film Roll with Entrapped Air and Method

(76) Inventor: Angel Gerardo Santillan Diaz de Leon, San Luis Potosi (MX)

Correspondence Address: THE H.T. THAN LAW GROUP, WATERFRONT CENTER SUITE 560, 1010 WISCONSIN AVENUE NW, WASHINGTON, DC, 20007, US

(21) Appl. No.: 12/298,981

(22) PCT Filed: Sep. 18, 2006
(86) PCT No.: PCT/MX2006/000097

§ 371 Date: Oct. 29, 2008

(30) Foreign Application Priority Data
May 3, 2006 (MX) GT/A/2006/000009

(51) Int. Cl. C08F 110/02; B29C 55/02

(52) U.S. Cl. 526/348.1; 264/288.4

(57) ABSTRACT

A pre-stretched film roll of a mono orientated linear low density polyethylene (LLDPE) is stretched between 30% and 320% from it's original length depending on the final product that is required. Stretching is in the machine direction (MD) at a controlled rate in two stages. Differentially rewinding the film entraps air between the layers of the roll and creates soft overlapping edges around the roll to produce a spongy, soft roll that prevents and resists drop damage due to its shock absorbent characteristic.

### BACKGROUND OF THE INVENTION

The present invention relates to stretch wrapping films, and particularly to a pre-stretched film roll with entrapped air and a method for making and winding a pre-stretched film roll of a linear low density polyethylene (LLDPE), stretched between 30% and 320% in the machine direction (MD), depending on the final product that is required, at a controlled rate in two stages, the film then being differentially rewound, thereby entrapping air between the layers of the roll to produce a spongy and soft roll that prevents and resists drop damage due to its shock absorbent characteristic.

### DESCRIPTION OF THE PRIOR ART

Rolls of stretch wrapping or cling-type film are used to wrap and secure bulky loads, such as boxes, onto pallets. Using film that has previously been plastically stretched simplifies the wrapping operation of palletized loads. The edges of pre-stretched stretchable film wound on a core are prone to damage and subsequently the yield of the roll is greatly hampered. For example, if dropped on the ground, weakness or holes are created in the margin of the film. The damage to the edges of the film can start tears while a load is being wrapped, handled or transported.

Prior art has supplied pre-stretched films that have reinforced edges, which are reinforced by annealing, hemming or folding the edge. These reinforced edges make a hard edged roll of stretch film, which is much more likely to become damaged. Winding machines have also been developed with an oscillating pattern for imparting an alternately layered margin to a roll of stretch film, thereby reducing the risk of damage to the edge of the film and subsequent tearing when the film is stretched.

U.S. Patent Application #20030189118, published Oct. 9, 2003 by Smith, is for a pre-stretched film having annealed edges, which is formed by supplying a pre-stretched web of thermoplastic material to a slitting and annealing station, slitting the pre-stretched web, thermally annealing the web along the slit line, and winding the slit and annealed material into rolls.

U.S. Pat. No. 5,565,222, issued Oct. 15, 1996 to Scherer, depicts an apparatus for hemming edges of stretch film and film having hemmed edges. A strip of stretch-wrap material is provided having flat, double thickness hems at opposite margins thereof. The hemmed strip is formed on apparatus including a first roller having a width less than the width of stock material fed into the machine, whereby opposite margins of the stock material project beyond opposite ends of the roller, and a second roller for guiding the strip at an acute angle from the first roller, causing the opposite marginal portions to fold. The strip is maintained under tension by a take-up roller or other means, and guide bars are provided for further folding the marginal portions beyond 90 degree angles, so that they continue to be folded inwardly against the main body of the strip.

U.S. Pat. No. 5,531,393, issued Jul. 2, 1996 to Salzsauler, provides a roll of stretched plastic film having an embossed surface for trapping air so as to facilitate unwinding of the roll of stretched film, stretched between 50 and 300 percent of the original length of the film, for wrapping pallet loads and particularly includes a folded edge for strengthening the edge, applied in a manner so as to minimize piling up of the rolled folded edge.

U.S. Pat. No. 6,592,699, issued Jul. 15, 2003 to Mehta, shows a process for making a highly stretched film that has permanently heat-sealed edges that are nearly invisible. A folding apparatus folds the edge portions of a film to form folded edges. The folded film then is passed through a bridle mechanism having two heated rolls. A series of nips apply pressure to the folded film as it is heated by the heated rolls. The nip pressure, combined with the heat imparted by the heated rolls, causes thermal welding of the folded edges resulting in permanent heat-sealed edges. Because the film edges are folded prior to the hot-stretching, the hot stretch process performs dual functions of stretching the film and heat sealing the folded edges. The resulting stretched film has permanently heat-sealed edges that do no separate, and which prevent tearing of the film edges during subsequent processing and use.

U.S. Pat. No. 5,967,437, issued Oct. 19, 1999 to Martin-Cocher, claims a machine for winding film, a method of manufacturing spools of pre-stretched film, and spools of pre-stretched film obtained as a result. The method for winding spools of pre-stretched stretchable film includes importing oscillation to the film with a component perpendicular to the axis of the film. For example, during pre-stretched and winding of the film on a take-up spool, a feed spool, a spool from which the stretchable film for stretching is taken, is caused to oscillate, and/or the take-up core is caused to oscillate. This ensures that successive layers of film are offset, in particular at the margins of the film. Spools of film obtained in this way do not have portions of extra thickness and lower tension at the margins as is the case prior art spools of pre-stretched film. Better resistance to being damaged when dropped and subsequent risk of tearing is obtained not only by having lower tension in the margin, but also by having a rounded edge to the roll of film on the spool.

U.S. Pat. No. 6,102,313, issued Aug. 15, 2000 to Salzsauler, describes a method and apparatus for producing coreless rolls of sheet material and a coreless roll of material. A roll of sheet material, such as plastic film wrap, having an inner layer wound at low tension and an outer layer wound under greater tension provides a coreless roll. Eliminating the need for a core reduces the cost of producing rolls of sheet material, and reduces the weight and outer dimensions of the roll with a consequent reduction in shipping and storage costs. An apparatus and method for producing such a roll, from a pre-wound master roll or as part of a production line for forming the sheet material, involves varying the longitudinal tension applied to sheet material as it is wound onto an expandable mandrel. After the roll has cured, the mandrel is collapsed and disengaged from the roll to provide a coreless roll. The mater roll can be pre-stretched prior to forming the coreless roll, if desired, and can be pre-stretched as a step in the formation of the coreless roll. The layers form a structure which enhances the ability of air to be trapped between the successive layers of the roll; such trapped air can help to provide rigidity to the completed roll prevents collapse of the roll once mandrel is removed.

U.S. Pat. No. 5,458,841, issued Oct. 17, 1995 to Shirrell, concerns a process and apparatus for producing pre-stretched plastic film. The method and apparatus are capable of forming a film from molten material and cooling the film to a non-molten condition so the film can be stretched. The cooled film is engaged and passed through a primary nip and second nip to plastically and elastically stretch the cooled film to cold orient the film such that the film is stretched beyond the material's yield point. The cooled film is engaged with a plurality of idler rollers at a relatively low tension over a distance sufficient to allow the cooled film to relax to recover a major portion of its elastic deformation. Thereafter, the film is formed into a roll prior to being affixed to a unit.

U.S. Pat. No. 6,375,781, issued Apr. 23, 2002 to Wojcik, illustrates an apparatus and high speed process for heating and stretching a film having a bridle mechanism comprising a first heated roll and a second heated roll. The film is stretched as the film is transferred from the first heated roll to the second heated roll which rotates at a speed greater than the speed at which the first heated roll rotates. The film is fed into the bridle mechanism at a rate of about 1,500 fpm to about 2,500 fpm wherein it is stretched to a length that is up to about 450% greater than its initial, pre-stretched length. The increased contact between the large diameter heated rolls and the film and the short draw gap between the two heated rolls result in a highly stretched film having minimal neck-in.

What is needed is a pre-stretched pallet wrap film roll that can be pre-stretched to a wide range of percentages of its length and differentially rewound to entrap air between the layers of the roll to produce a shock resistant roll that is easy to use and a method of making such a film.

### DESCRIPTION OF THE INVENTION

An object of the present invention is to provide a pre-stretched pallet wrap film roll and method of making the film that can be pre-stretched in a two stage process to a wide range of percentages of its length and differentially rewinding the roll to entrap air between the layers of the film in the roll to produce a shock resistant roll that is easy to use and is approximately half the weight of conventional stretch films used in hand application.

A related object of the present invention is to provide a roll of film that is stretched in a two step process by three polyurethane covered rollers running at different individually controlled speeds set and transmitted through a chain and sprocket or synchronous belt transmission to pre-stretch the film through a range from 30% to 320% of the original length of the film.

Another related object of the present invention is to provide a stretching method and apparatus construction wherein the film is forced to wrap around the stretcher rolls by the idler roll assembly carriage to facilitate raw material threading into the machine.

A further object of the present invention is to provide an idler roller assembly carriage that can be separated from the machine base, which carriage swings out to allow easy threading of the raw material, and once the machine is threaded, the carriage is locked back into position by a couple of air cylinders with the stretch film between the stretcher rolls and the idler rolls to create an easy and fast step for loading the material to carry out the method.

Still another object of the present invention is to provide a pre-stretched film roll that has air entrapped by a differential rewind method, which facilitates air being caught between the successive layers of the pre-stretched film as it is rewound in the rewind segment of the apparatus.

In brief, a pre-stretched film roll and a method that stretches a linear low density polyethylene (LLDPE), mono oriented or stretched, between 30% and 320% over the original raw film length, depending on the final product that is required, in the machine direction (MD) at a controlled rate in two stages. The film is then differentially rewound, thereby entrapping air between the layers of the roll to produce a spongy, soft roll that prevents and resists drop damage due to its shock absorbent characteristic.

One of the advantages of the present invention is that it provides a pallet wrapping film that can be pre-stretched between 30% and 320% as needed for particular applications.

An additional advantage of the present invention is that it provides a pre-stretched film wrap roll with entrapped air to produce a shock absorbing roll.

One more advantage of the present invention is that it provides a pre-stretched pallet wrapping film roll that is pre-stretched an appropriate amount for the job to make it easy to use and prevent injury by avoiding the effort required to hand stretch film.

Yet another advantage of the present invention is that it is only approximately half the weight of conventional stretch films for easier handling.

A further advantage of the present invention is that it provides an easy and fast step for loading the material to carry out the method.

### BRIEF DESCRIPTION OF THE DRAWINGS

These and other details of my invention will be described in connection with the accompanying drawings, which are furnished only by way of illustration and not in limitation of the invention, and in which drawings:

FIG. 1—Is a schematic side elevation view of the pre-stretched film of the present invention being stretched in the film stretching apparatus and wound onto a roll carrying out the method of the present invention.

FIG. 2—Is a schematic side elevation view of the pre-stretched film and apparatus of FIG. 1, showing the vertical array of idler rollers in the open position and away from the active stretcher rollers to allow the film to be loaded into the apparatus.

FIG. 3—Is a schematic end elevation view of a finished roll of the pre-stretched film of the present invention.

FIG. 4—Is a schematic front elevation view of a finished roll of the pre-stretched film of the present invention.

FIG. 4A—Is a schematic exploded view of an overlapping edge of the rewound pre-stretched film of the present invention showing the angled overlapping edge and the air entrapped between layers of the film on the roll.

FIG. 5—Is a schematic top plan view of the rewind station of the present invention.

FIG. 6—Is a schematic side elevation view of the rewind station of the present invention.

FIG. 7—Is a schematic cross-sectional view of the rewind station of FIG. 6.

### BEST MODE FOR CARRYING OUT THE INVENTION

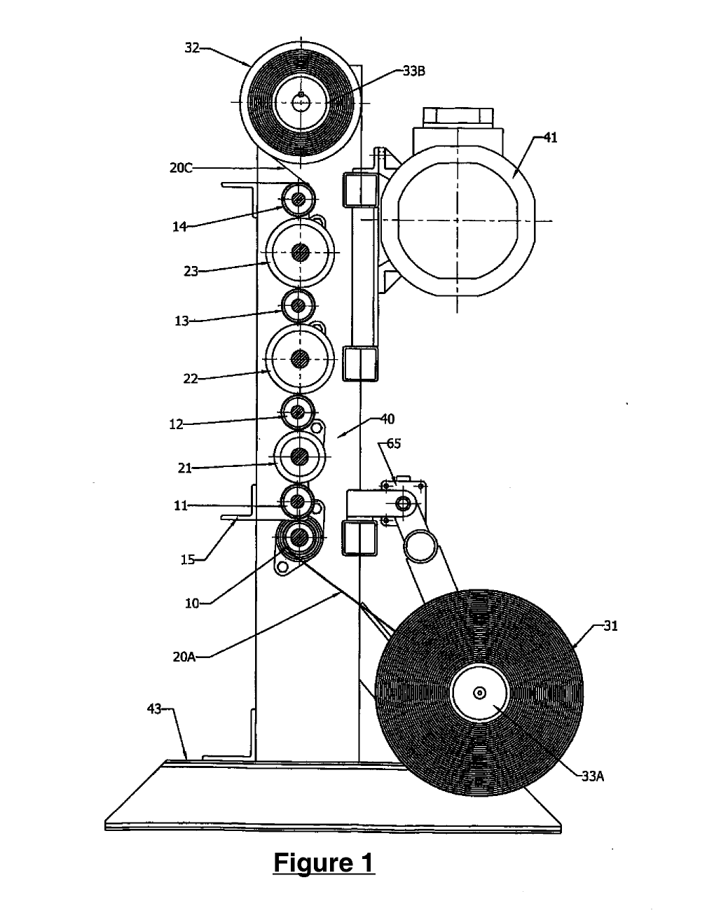

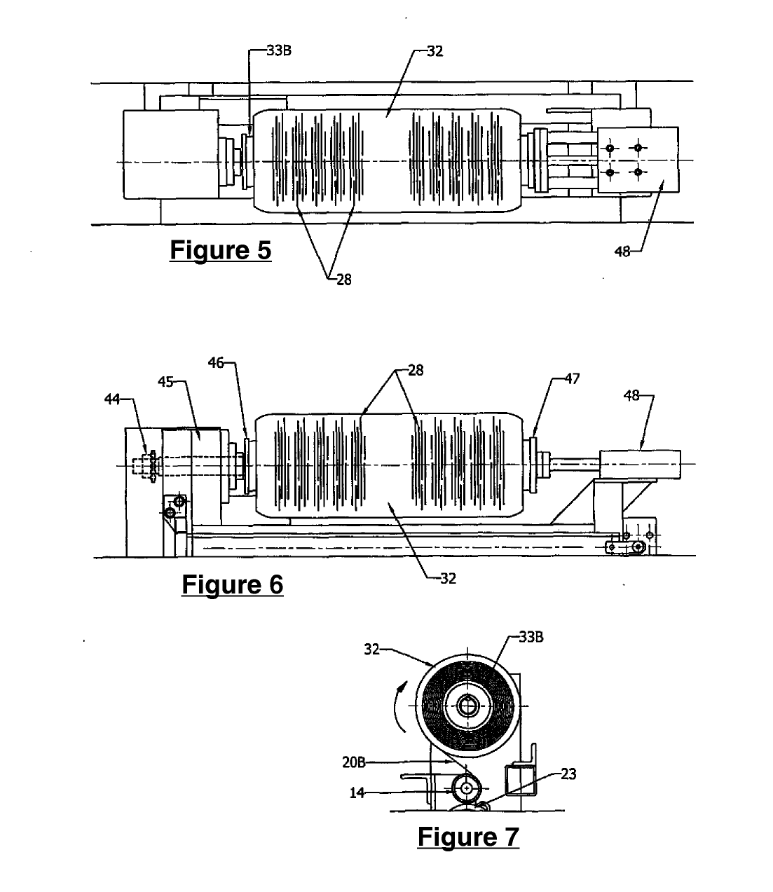

In FIGS. 1-7, the present invention comprises a pre-stretched film 20B for stretch wrapping large items, the stretching apparatus for carrying out the method of the present invention, and a finished roll of the pre-stretched and rewound film with entrapped air between layers of the film.

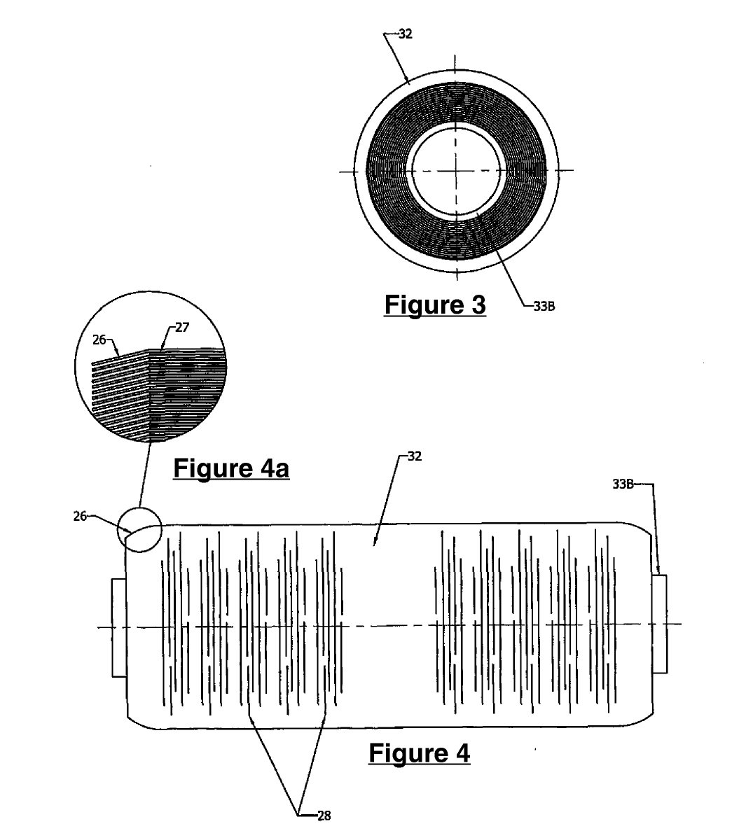

In FIG. 1, a pre-stretched film 20B of a linear low density polyethylene (LLDPE) is pre-stretched from a raw film 20A unstretched length from the first roll 31 to a desired length to meet usage requirements in the machine direction (parallel to the side edges) at a controlled rate in two stretching stages. The pre-stretched film has stretch lines 28 in the machine direction parallel to the sides of the film, as seen in the finished pre-stretched roll 32 of FIGS. 3 and 4. The pre-stretched film 20B is wound onto a second roll 32 with the pre-stretched film 20B wound around a cardboard center 33B, with entrapped air spaces 27, as shown in FIG. 4A, between layers of the pre-stretched film produced by the method of differential rewinding of the pre-stretched film thereby entrapping air 27 between the layers of the pre-stretched film on the roll, thereby creating a shock absorbing roll having a spongy soft resiliency that prevents and resists drop damage due to its shock absorbing characteristic.

The pre-stretched film can be stretched the desired amount depending on usage to any pre-stretched film length between 30% and 320% greater than the raw film length.

In FIG. 1, a method of pre-stretching film and forming a roll of pre-stretched film with entrapped air and overlapping soft edges for stretch wrapping large items comprises a two step method:

A first step comprises pre-stretching a film of linear low density polyethylene (LLDPE) from a raw film 20A on a first roll 31 of an unstretched length to a desired length to meet usage requirements stretching the film in a machine direction producing stretch lines 28 parallel to the side edges of the film at a controlled rate in two stretching stages forming stretch lines in the film in the machine direction and rolling the pre-stretched film 28B onto a second roll 32.

The pre-stretched film may be stretched any desired amount producing a pre-stretched film 20B length between 30% and 320% greater than the raw film 20A length.

The first step comprises stretching of the film on three polyurethane covered rollers 21, 22, and 23 running at different increasing and individually controlled speeds, a first stretching phase occurring between a first roller 21 and a second roller 22 stretching the film between 30% and 150% greater than the length of the raw film, and a second stretching phase occurring between the second roller 22 and a third roller 23 stretching the film between 0% and 170% greater than the length of the film obtained in the first stretching phase. The incremental speeds in the rolls are set and transmitted thru a chain and sprocket or synchronous belt transmission.

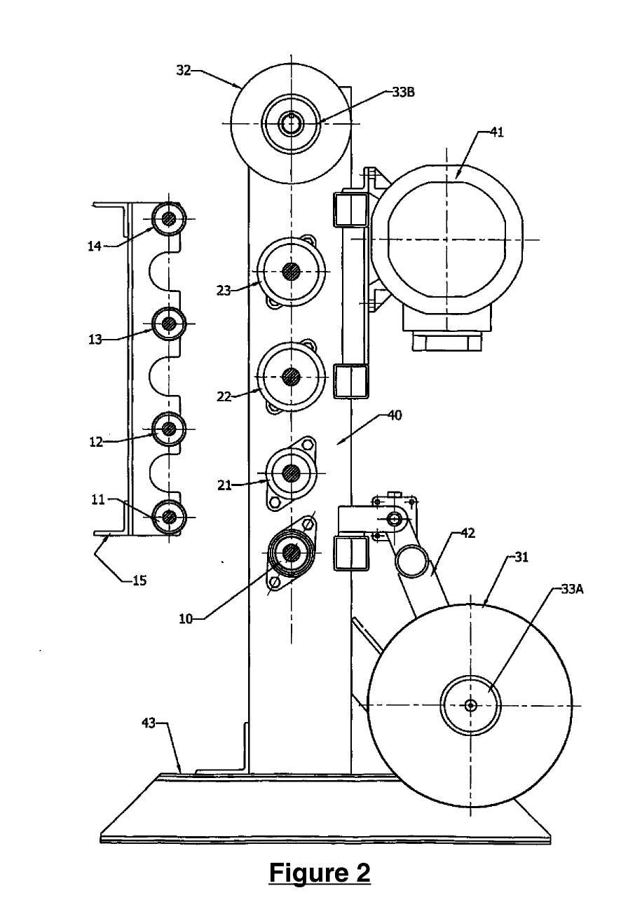

In FIG. 2, an idler roller assembly carriage 15 is separated from the machine base and swings out to allow easy threading of the raw film 20A from the first roll 31. Once the machine is threaded the carriage is locked back into position by a couple of air cylinders with the stretch film between the stretcher rollers 21, 22, and 23 and the idler rollers 10, 11, 12, 13, and 14.

In FIGS. 5, 6, and 7, a second step comprises differentially rewinding the second roll 32 of pre-stretched film thereby entrapping air 27 between a series of layers of the pre-stretched film 20B on the second roll 32 to produce air spaces 27 between the layers of the pre-stretched film 20B and producing an overlapping soft edge 26, as seen in FIG. 4A, thereby creating a shock absorbing second roll 32 having a spongy soft resiliency that prevents and resists drop damage due to its shock absorbing characteristic.

In FIGS. 5 thru 7, the differential rewinding step comprises a cardboard core 33B of the second roll 32 that slips over a fixed speed mandrel 46 at a controlled rate via the amount of pressure exerted by a guided air cylinder 48 allowing for differential take-up of the material 20B as the roll 32 grows in diameter. This differential take-up enhances air entrapment 27, as seen in FIG. 4A, between the layers of the film as they are rewound on the cardboard core 33B. Peripheral speed at the cardboard core is set up 5 to 20% higher than the peripheral speed of the third stretcher roller 23.

In use, the pre-stretched film 20B is unwound from the roll 32 around a pallet or other large item and the film automatically clings to and secures the pallet or other large item without requiring undue strain in winding the film due to the fact that it has already been pre-stretched to the desired length for the job.

It is understood that the preceding description is given merely by way of illustration and not in limitation of the invention and that various modifications may be made thereto without departing from the spirit of the invention as claimed.

Having described my invention sufficiently, it is considered to be novel and I claim to be my exclusive property, what is contained in the following claims:

1. A pre-stretched film for stretch wrapping large items, the film comprising: a pre-stretched film of a mono orientated linear low density polyethylene (LLDPE) pre-stretched from a raw unstretched film length to a desired length to meet usage requirements in the machine direction at a controlled rate in two stretching stages, the pre-stretched film having stretch lines in the machine direction, the pre-stretched film wound into a roll with air spaces between layers of the pre-stretched film produced by differential rewinding of the pre-stretched film thereby entrapping air between the layers of the pre-stretched film on the roll and soft overlapping edges around the roll, thereby creating a shock absorbing roll having a spongy soft resiliency that prevents and resists drop damage due to its shock absorbing characteristic.

2. The pre-stretched film of claim 1 wherein the pre-stretched film length is between 30% and 320% greater than the raw film length.

3. A method of pre-stretching film for stretch wrapping large items, the method comprising: a first step of pre-stretching a film of a mono oriented linear low density polyethylene (LLDPE) from a raw film on a first roll of an unstretched length to a desired length to meet usage requirements stretching the film in a machine direction at a controlled rate in two stretching stages forming stretch lines in the film in the machine direction and rolling the film onto a second roll and; a second step of differentially rewinding the second roll of pre-stretched film thereby entrapping air between a series of layers of the pre-stretched film on the second roll to produce air spaces between the layers of the pre-stretched film and soft overlapping edges around the roll, thereby creating a shock absorbing second roll having a spongy soft resiliency that prevents and resists drop damage due to its shock absorbing characteristic.

4. The method of claim 3 wherein the first step comprises stretching the film to a length between 30% and 320% greater than the raw film length.

5. The method of claim 3 wherein the first step comprises stretching of the film on three polyurethane covered rollers running at different increasing and individually controlled speeds, a first stretching phase occurring between a first and a second polyurethane covered rollers and a second stretching phase occurring between the second and a third polyurethane covered rollers.

6. The method of claim 3 wherein the second step of differentially rewinding comprises providing a core of the second roll which slips over a fixed speed mandrel at a controlled rate via the amount of pressure exerted by a guided air cylinder allowing for differential take-up of the pre-stretched film as the second roll grows in diameter,

7. The method of claim 6 wherein a core peripheral speed is set up 5% to 20% higher than a peripheral speed of the third roller.
